(19) United States
(12) Patent Application Publication
(10) Pub. No.: US 2020/0193437 A1
(43) Pub. Date: Jun. 18, 2020

(54) Direct Allocation System

(71) Applicant: Earned LLC, Longmont, CO (US)

(72) Inventors: Timothy L. Robinson, Alexandria, VA (US); Bradford R. Schildt, Longmont, CO (US)

(73) Assignee: Earned LLC, Longmont, CO (US)

(21) Appl. No.: 16/800,854

(22) Filed: Feb. 25, 2020

Related U.S. Application Data
(63) Continuation-in-part of application No. 15/886,737, filed on Feb. 1, 2018, now Pat. No. 10,572,862.
(60) Provisional application No. 62/563,321, filed on Sep. 26, 2017.

(51) Int. Cl. G06Q 20/40; G06Q 20/24; G06Q 40/02; G06Q 40/00

(52) U.S. Cl. CPC G06Q 20/405; G06Q 40/125; G06Q 40/025; G06Q 20/24

(57) ABSTRACT

A method is provided. The method includes one or more of establishing a card account for a consumer, determining, by a banking server, wage earnings for the consumer, determining an available spending limit equal to a spending limit minus a sum of a purchase balance and a transfer balance, approving one or more purchase transactions for the card account not greater than the available spending limit, selecting, by a-user interface control, the transfer balance including a portion of the available spending limit to transfer to a designated account, transferring the transfer balance to the designated account, crediting, by an employer server, a primary account with the wage earnings on a payday, and in response transferring an amount equal to a portion of the sum of the transfer balance and the purchase balance from the primary account to a secondary account on or after the payday and adjusting the available spending limit.

### CROSS REFERENCE TO RELATED APPLICATIONS

This application is a continuation-in-part of application Ser. No. 15/886,737, filed Feb. 1, 2018, titled “CREDIT MANAGEMENT METHOD AND SYSTEM”, which claims priority from earlier filed provisional application No. 62/563,321 filed Sep. 26, 2017, titled “A SYSTEM AND METHOD TO INCREASE FINANCIAL INCLUSION WHEN ISSUING CREDIT CARDS”, the entire contents of which are hereby incorporated by reference.

### FIELD

The present invention is directed to methods and systems to approve and manage consumer financial cards, and in particular provide a direct allocation system.

### BACKGROUND

Credit cards are a valuable way to make purchases and function in today's world. They are very useful to smooth one's cash flows, and allow easy access to car rentals, booking hotels, and making purchases over the internet. Credit cards also provide protections to the cardholder that are not available to debit card users. When debit cards are used, the funds are withdrawn from a cardholder's checking account on the day of the transaction, while with a credit card there is the financial protection of a built in “layer” associated with transactions. This protection takes the form of a statement which is transmitted to the card holder before they must pay for the transaction. In this way, a customer using a credit card doesn't run the risk of over-drafting their checking account because of unexpected or unaccounted-for debits to their account including fraudulent transactions. Unexpected or unaccounted-for debits to a user's checking account can have a domino effect of financial headaches and can tie up funds, leading to the decline of legitimate charges which cause overdrafts. Another significant benefit of a credit card over a debit card is that the user's payment history is reported to various credit reporting agencies. When properly utilized, credit cards can increase a user's credit score. This benefit can help lower other borrowing costs for a consumer. For instance, if one doesn't have a credit score or has a low credit score and attempts to purchase a car, the interest rate charged will be significantly higher than if one has established a positive credit score by utilizing a credit card. However, in order to obtain a credit card from most banks, one has to have a credit score to begin with or not have a low or “sub-prime” credit score.

While very valuable, an improperly managed credit card can easily saddle consumers with high interest debt, preventing them from using their money in other ways. This is one reason some people use a debit card; to prevent themselves from incurring debt. Many people have a job and have a checking account and utilize a debit card associated with their checking account. When they receive their wages and have money in their checking account, they make purchases with a debit card. This debit card usage is not reported to the credit agencies and the user's credit score does not reflect this usage. What would be better is for the consumer to utilize a credit card and pay their credit card bill when they get paid, without incurring long term debt. However, without a high enough credit score, obtaining a credit card may be difficult.

One reason banks require a positive credit score is related to the requirement that credit card users be provided with advance notice before their payment is due. While many people get paid weekly or bi-weekly, banks issuing credit cards are only allowed to bill a customer once a month and they must provide 21 days for the customer to pay their bill before they can accrue interest if their previous bill has been paid in full (unless they don't provide any grace period on interest in the first place and few banks do this).

### SUMMARY

The present invention is directed to solving disadvantages of the prior art. In accordance with embodiments of the present invention, a method is provided. The method includes one or more of establishing a card account for a consumer, determining, by a banking server, wage earnings for the consumer, determining, by the banking server, an available spending limit equal to a spending limit minus a sum of a purchase balance and a transfer balance, approving, by the banking server, one or more purchase transactions for the card account not greater than the available spending limit, selecting, by a—user interface control, the transfer balance including a portion of the available spending limit to transfer to a designated account, transferring the transfer balance to the designated account, crediting, by an employer server, a primary account with the wage earnings on a payday, and in response transferring, by the banking server, an amount equal to a portion of the sum of the transfer balance and the purchase balance from the primary account to a secondary account on or after the payday, and adjusting, by the banking server, the available spending limit based on the total accrued fractional earnings, the purchase balance, the transfer balance, and the secondary account balance. The spending limit includes total accrued fractional earnings, the total accrued fractional earnings include a sum of fractional earnings, and fractional earnings include a predetermined fraction of the wage earnings. The secondary account includes a secondary account balance for storing funds to pay a card account statement balance.

In accordance with another embodiment of the present invention, a system is provided. The system includes one or more of a network, a merchant device, a secondary account, an employer server, a banking server, and a consumer device. The merchant device is configured to perform one or more purchase transactions for a consumer using a card account. The consumer device is coupled to the network and includes a user interface, which includes a payment selection slider configured to allow the consumer to select a transfer balance that includes a portion of an available spending limit to transfer to a designated account. The banking server is coupled to the network and is configured to receive payment instructions related to the consumer, calculate wage earnings from the payment instructions, approve the one or more purchase transactions not greater than the available spending limit for the card account, receive the transfer balance from the consumer device, and in response reduce the available spending limit by the transfer balance. The employer server is coupled to the network and is configured to transfer the consumer wage earnings to a primary account on a payday. In response to the employer server configured to transfer the consumer wage earnings, the banking server is further configured to transfer an amount equal to a portion of the sum of the transfer balance and the purchase balance from the primary account to the secondary account on or after the payday, transfer up to a card account statement balance from the secondary account to the card account on or before a card statement due date, and adjust the available spending limit based on the total accrued fractional earnings, the purchase balance, the transfer balance, and the secondary account balance. The secondary account is coupled to the network and the available spending limit is equal to a spending limit minus a sum of a purchase balance for the card account and the transfer balance. The spending limit includes total accrued fractional earnings, the total accrued fractional earnings include a sum of fractional earnings, and the fractional earnings include a predetermined fraction of the consumer wage earnings.

In accordance with yet another embodiment of the present invention, a non-transitory computer readable storage medium is provided. The non-transitory computer readable storage medium includes instructions that when executed cause a processor to one or more of establish a card account for a consumer, determine, by a banking server, wage earnings for the consumer, determine, by the banking server, an available spending limit equal to a spending limit minus a sum of a purchase balance and a transfer balance, approve, by the banking server, one or more purchase transactions for the card account not greater than the available spending limit, select, by a user interface control, the transfer balance including a portion of the available spending limit to transfer to a designated account, transfer the transfer balance to the designated account, credit, by an employer server, a primary account with the wage earnings on a payday, and in response, transfer, by the banking server, an amount equal to a portion of the sum of the transfer balance and the purchase balance from the primary account to a secondary account on or after the payday and adjust, by the banking server, the available spending limit based on the total accrued fractional earnings, the purchase balance, the transfer balance, and the secondary account balance. The secondary account includes a secondary account balance for storing funds to pay a card account statement balance. The spending limit includes total accrued fractional earnings, the total accrued fractional earnings include a sum of fractional earnings, and fractional earnings include a predetermined fraction of the wage earnings.

In accordance with yet another embodiment of the present invention, a user interface is provided. The user interface includes one or more of an available to spend amount for a card account, a sliding payment selection control, and a transfer funds control. The available to spend amount includes a spending limit minus a sum of a purchase balance and a transfer balance. The spending limit includes total accrued fractional earnings, the total accrued fractional earnings include a sum of fractional earnings, and fractional earnings include a predetermined fraction of consumer wage earnings. The available to spend amount initially reflects an amount that may be spent on a credit card. The sliding payment selection control is configured to allow a consumer to select a portion of the available to spend amount to transfer to a designated account. The selected portion ranges from a minimum amount up to the available to spend amount. The sliding payment selection control reflects the minimum amount when the user interface is invoked. The transfer funds control is configured to authorize transfer of the selected portion to a banking server and reduce the available to spend amount by the selected portion.

One advantage of the present invention is that it provides a method for managing credit and cash flow for consumers who are paid hourly, with a salary, from government wages, or on a consulting or project basis.

Another advantage of the present invention is it provides a cash flow smoothing process and will help increase a consumer's credit score. Especially for low income or young people making an hourly wage, cash flow must be carefully managed in order to not overdraw bank accounts, not make late payments, and pay bills on time.

Another advantage of the present invention is it provides a novel consumer user interface to manage available funds transfers. A consumer may transfer funds to a designated account, which may then be withdrawn later as cash.

Another advantage of the present invention is the ability of a system operator to increase the credit amount available to the consumer based on the income earned by the consumer or money owed to the consumer.

Yet another advantage of the present invention is it allows the consumer to provide input each payday into how much of their available funds are allocated to paying a card statement. This gives greater control and flexibility to consumers.

Additional features and advantages of embodiments of the present invention will become more readily apparent from the following description, particularly when taken together with the accompanying drawings. This overview is provided to introduce a selection of concepts in a simplified form that are further described below in the detailed description. It may be understood that this overview is not intended to identify key features or essential features of the claimed subject matter, nor is it intended to be used to limit the scope of the claimed subject matter.

### BRIEF DESCRIPTION OF THE DRAWINGS

FIG. 1A is a block diagram illustrating account transfers directly to a card account, in accordance with embodiments of the present invention.

FIG. 1B is a block diagram illustrating account transfers through a pool, in accordance with embodiments of the present invention.

FIG. 2 is a diagram illustrating a user interface configuration of a designated account, in accordance with embodiments of the present invention.

FIG. 3A is a diagram illustrating a direct transfer user interface screen, in accordance with a first embodiment of the present invention.

FIG. 3B is a diagram illustrating a direct transfer user interface screen, in accordance with a second embodiment of the present invention.

FIG. 3C is a diagram illustrating a designated account transfer amount selection screen, in accordance with embodiments of the present invention.

FIG. 3D is a diagram illustrating an updated designated account transfer user interface screen, in accordance with embodiments of the present invention.

FIG. 4A is a diagram illustrating a first pool allocation user interface screen, in accordance with embodiments of the present invention.

FIG. 4B is a diagram illustrating a second pool allocation user interface screen, in accordance with embodiments of the present invention.

FIG. 4C is a diagram illustrating an allocate amount to pool user interface screen, in accordance with embodiments of the present invention.

FIG. 4D is a diagram illustrating an allocate full amount to pool user interface screen, in accordance with embodiments of the present invention.

FIG. 4E is a diagram illustrating an updated card account user interface screen after transferring full amount, in accordance with embodiments of the present invention.

FIG. 5A is a diagram illustrating a pool transfer to a designated account and/or a card account user interface screen, in accordance with embodiments of the present invention.

FIG. 5B is a diagram illustrating a pool transfer to a designated account selection screen, in accordance with embodiments of the present invention.

FIG. 5C is a diagram illustrating a pool allocation to card account selection screen, in accordance with embodiments of the present invention.

FIG. 5D is a diagram illustrating an update transfer to designated account and/or allocate to card account user interface screen, in accordance with embodiments of the present invention.

FIG. 6A is a diagram illustrating a displayed credit information user interface screen, in accordance with embodiments of the present invention.

FIG. 6B is a diagram illustrating a user interface payment amount selection screen, in accordance with embodiments of the present invention.

FIG. 7 is a flowchart illustrating a card account management process without a pool, in accordance with embodiments of the present invention.

FIG. 8 is a flowchart illustrating a card account management process with a pool, in accordance with embodiments of the present invention.

### DETAILED DESCRIPTION

Credit cards provide a tremendous benefit to consumers through smoothing of inconsistent cash flows due to payday schedules, permitting delayed payment for purchases, and increasing consumer credit scores. These features, however, are only available to consumers with an acceptable credit rating and an available credit limit on an existing card. Additionally, credit cards typically come with a substantial penalty to the consumer if the credit card provider is not paid in full at the end of the billing cycle. With these standard credit cards, late fees and high interest rate charges can continue to accrue at an alarming rate, thereby placing a tremendous cost on the consumer.

These existing credit cards are not available to a significant portion of consumers, and many consumers with credit cards do not want to use them and potentially incur additional debt. Additionally, for consumers with balances on credit cards, interest is charged from the date of the transaction. These consumers frequently use debit cards, which deduct the transaction amount from a positive balance checking account at the time of the transaction, or at the end of the business day. Debit card customers are unable to make purchases at merchants when their account balances are not positive. For the 76% of the US population that lives paycheck to paycheck and the 47% that cannot make a $400 emergency payment, the time period immediately preceding a payday is one in which they can make no purchases. Employers typically pay their employees weekly or biweekly in arrears, effectively creating a system where employees finance the employer. This system is in place as daily payments are not cost effective as each payment incurs a processing fee, as well as administration time and costs. While businesses use factoring services to finance receivables, employees need a similar service to obtain payment for their services prior to their employers' payroll schedule.

In accordance with the present invention, a new card management system and consumer device user interfaces are provided to create financial inclusion to a group of consumers not currently served by existing systems. What is needed is a more flexible computer-processed payment device, which allows banks to issue cards to consumers with poor or no credit while complying with consumer lending regulations. A more flexible payment device also allows banks to manage variable credit limits for consumers based on pending income and allows consumers to manage their credit balance by setting aside funds on payday to pay their bill in the future.

The present invention meets these needs by providing a credit management system that allows consumers to reserve funds to pay their card bill. Allowing a consumer to manage their cash flow and improve their credit score utilizing a card and a secondary bank account for inter-pay period transactions will increase financial inclusion. Customers can better manage their cash flow and can shift transactions they would have paid via debit card to a credit card, thereby allowing them to improve their credit scores. In the following description, the use of the terms “user” or “consumer” and “merchant” is not intended to limit the scope of the present invention.

Parent application Ser. No. 15/886,737 discloses in significant detail many aspects of the present application that are not described in the same amount of detail herein, and should be consulted for that detail. For example, “servers” including merchant devices 104, an employer server (not shown), or banking server 108 or consumer device 136 are described in more detail in application Ser. No. 15/886,737. Various example calculations for fractional earnings, total accrued fractional earnings, spending limits, and account transfers are also provided and should be consulted as the basis for similar calculations herein. The present application includes some calculations that are not included in the parent application, and where differences exist, the present application applies and should be consulted.

Data structures and parameters described fully in the parent application are involved in operation of the various embodiments of the present application, and may include fractional earnings, an accrued earnings fraction, daily earnings, total accrued fractional earnings, a credit limit, a purchase balance, a current purchase balance, a secondary account balance, a spending limit, and a card account statement balance. Parameters may include other parameters useful for performing the processes of the present invention. For example, a consumer may be notified of a current maximum amount they can purchase, which was called the available spending limit in parent application Ser. No. 15/886,737. The available spending limit as previously defined was equal to the spending limit minus the purchase balance, but is redefined herein as an available spending limit 132 and an adjusted available spending limit 152 and as described below.

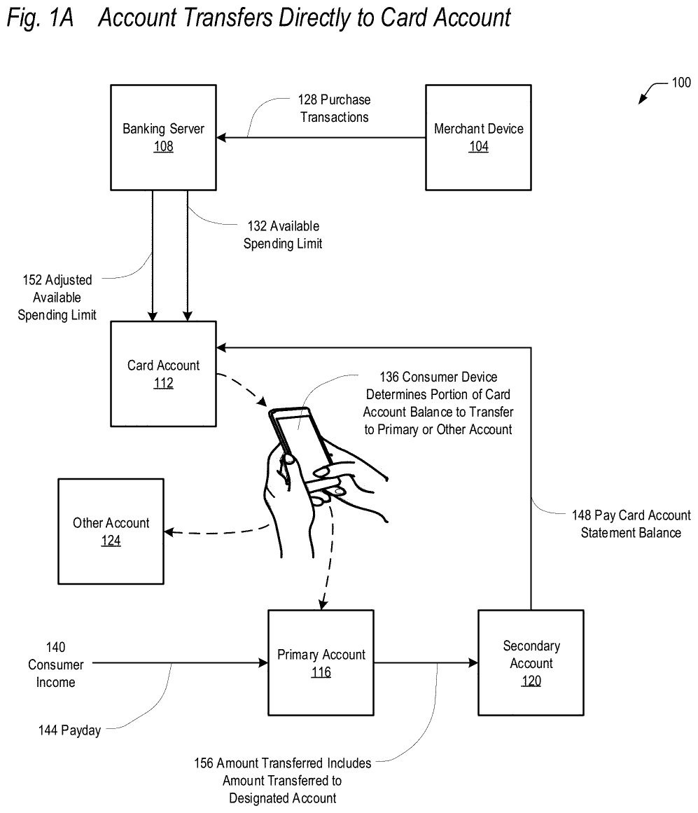

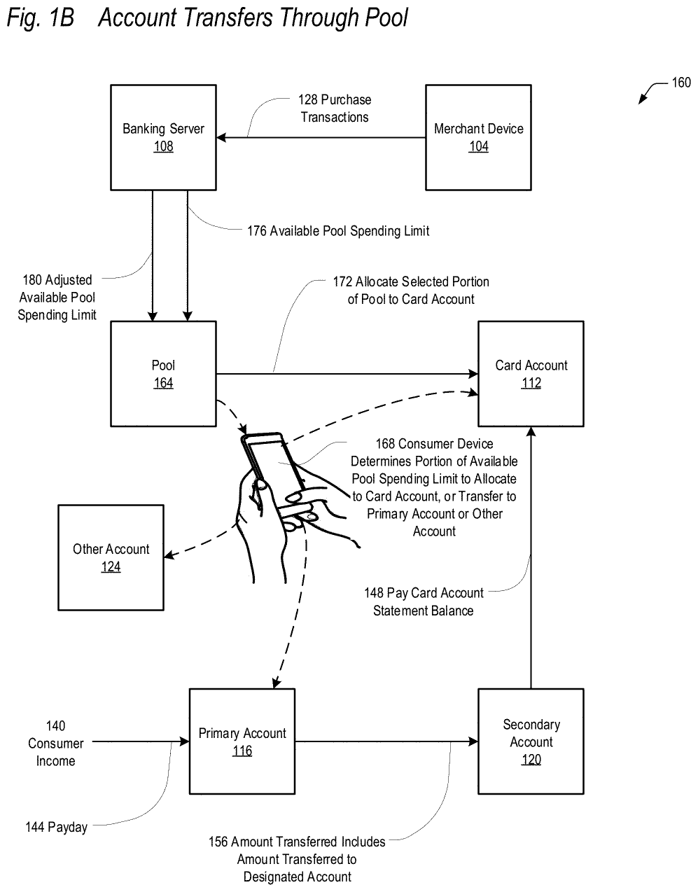

Referring now to FIG. 1A, a block diagram illustrating account transfers directly to a card account 100, in accordance with embodiments of the present invention is shown. A purchasing and payment network 100 may include one or more networks or a cloud (not shown), which may provide intercommunication infrastructure between various entities involved with the processes of the present invention. Such networks may include, but are not limited to, wireless telecommunication networks, LANs (Local Area Networks), WANs (Wide Area Networks), WLANs (Wireless LANs), WWANs (Wireless WANs), telecommunication networks, baseband and broadband networks, and so forth. Networks may also represent the Internet or one or more cloud networks, possibly including many servers, databases, and other devices.

Purchasing and payment networks 100 may include one or more merchant devices 104 to conduct various purchase transactions. Merchant devices 104 may include one or more point of sale (POS) terminals, which typically include a computer, a cash register, and other equipment or software used to sell goods or services. Merchant devices 104 transmit sales data to be posted to customer accounts, and may include one or more servers with associated databases and other configurations useful for making purchase transactions 128.

Purchasing and payment networks 100 may also include one or more employer servers (not shown), which manage employee payroll processing and transfers consumer income 140 to a primary account 116 on a payday 144. A payday 144 may be on a regular interval, such as weekly, biweekly, or monthly, or irregularly such as when a project or work item is completed or other random or quasi-random basis.

Purchasing and payment networks 100 may also include one or more banking servers 108. Banking servers 108 are operated by banks, other financial institutions, or third party processors connected to various financial networks for processing financial transactions. Banking servers 108 sets up and manage card accounts 112 and perform ACH functions: 1) debits the primary account 116 and credits a reserve or secondary account 120; 2) debits the secondary account 120 to the issuing bank (i.e. banking server 108); and 3) determines the spending limit and the available spending limit 132. The banking server 108 of the present application is associated with a specific lender, which may be a bank, a credit union, another financial institution, an individual, a group of individuals, or an organization.

Card accounts 112 may be credit card accounts, debit card accounts, or hybrid card accounts (i.e. having both credit and debit properties), and the card may be a credit card, debit card, or a hybrid card. The card account 112 is associated with a specific lender, which may be a bank, a credit union, another financial institution, an individual, a group of individuals, or an organization. In one embodiment, the lender associated with the banking server 108 may be the same lender associated with the card account 112. In another embodiment, the lender associated with the banking server 108 may be a different lender than the lender associated with the card account 112. In one embodiment, the card account 112 may include the secondary account 120. Banking server 108 may access a database (not shown) to access various financial accounts related to a consumer. For example, third party databases may contain information relating to the financial history of the consumer or other information about the consumer that may be used in scoring or otherwise determining when and in what amounts to approve transactions for the consumer. Funds transfer instructions may be transmitted from the database to an issuing bank, a secondary account 120 bank, and a primary account 116 bank, or any other financial intermediary.

Purchasing and payment network 100 may also include one or more client or consumer devices 136 for an employee or consumer. The consumer may be an hourly employee, salaried employee, a contractor (performing work on a project or other basis), or someone receiving government benefits and not necessarily employed by the employer. In the case of a consumer receiving government benefits, an employer server may be operated by a government entity or third party processor and the actions associated with the employer may instead performed by the government entity or third party processor. The consumer device 136 may be any type of computing device suitable for communicating with the purchasing and payment network 100, and displays various information on user interface screens described herein. Consumer device 136 includes but is not limited to personal computers (PCs), handheld PCs, laptops, tablets, personal data assistants (PDA), mobile telephones, smartphones, smart accessories (e.g., a smartwatch, GOOGLE glasses, etc.), mobile internet devices, computer chip biological implants, and so forth.

Associated with the consumer is the primary account 116, which stores consumer earnings 140. The primary account 116 is typically a checking account at a bank, credit union, savings and loan, or other financial institution. The financial institution associated with the banking server 108 stores consumer information, including information about at least one financial account. Various other items of information, including but not limited to consumer name, consumer address, employer, ID number and phone number may also be stored in a system database (not shown). In one embodiment, the system database may be partitioned and may be located across multiple physical locations or in a cloud; furthermore, a system may include more than one system database, and such databases would work cooperatively. For example, information pertaining to card transactions may be retrieved from a system database operated by an issuing bank while instructions for payment processing may be stored on a remote system database that is not operated by the issuing bank. Each payday 144, a certain amount of funds may be transferred from the primary account 116 to the secondary account 120. The funds in the primary account 116 are provided by an employer or government entity based on consumer income 140. The amount of funds transferred 156 may be an amount equal to a portion of the sum of the transfer balance and the purchase balance.

Also associated with the consumer is the secondary account 120, which is typically a checking account at a bank, credit union, savings and loan, or other financial institution. The secondary account 120 stores funds used to pay a card account statement balance 148. A card account statement is issued to the consumer on a regular basis, typically monthly, and specifies a due date by which a payment or credit card statement balance 148 should be made. The financial institution controlling the primary account 116 may be different from or the same as the financial institution controlling the secondary account 120.

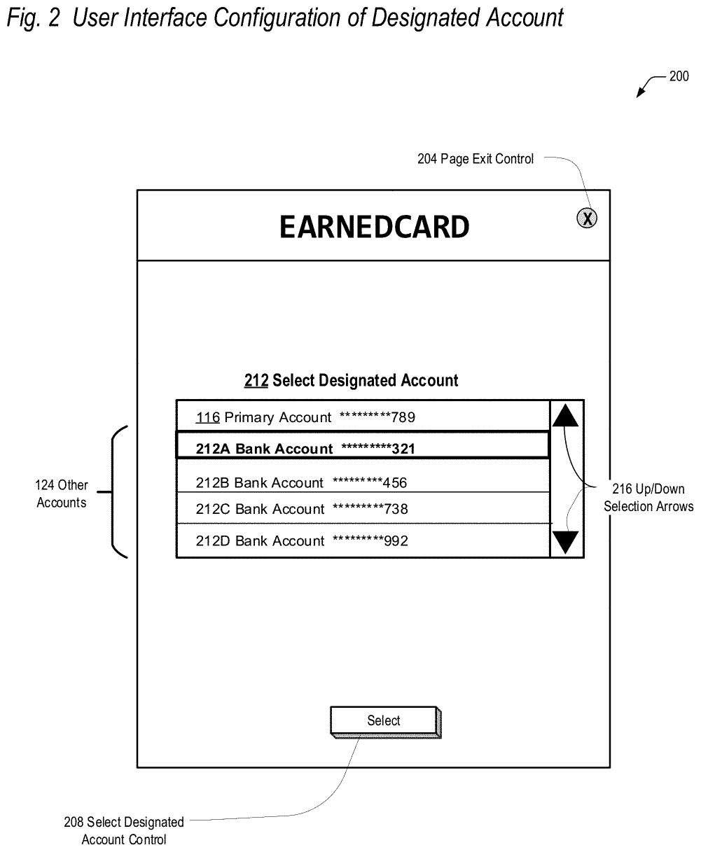

The consumer device 136 may determine a portion of the card account 112 to transfer to a designated account 212. The designated account 212 may include the primary account 116 or another account 124. The other account 124 may be a checking account like the primary account 116 at a bank, credit union, savings and loan, or other financial institution, but is physically distinguished as a separate account from either the primary account 116 or the secondary account 120. In an additional embodiment the other account 124 may be the primary account 116. The other account 124 may be designated by a configuration user interface screen similar that shown in FIG. 2, or may be a fixed or dedicated account that may not be identified or selected as shown.

In an additional embodiment, the banking server 108 and/or system database may also make use of data received from third party databases (not shown). In various embodiments, third party databases may contain information relating to the financial history of the consumer or other information about the consumer that may be used in scoring or otherwise determining when and in what amounts to approve transactions for consumer. Funds transfer instructions may be transmitted from the system database to an issuing bank, secondary account bank, primary account bank, or any other financial intermediary.

Referring now to FIG. 1B, a block diagram illustrating account transfers through a pool 160, in accordance with embodiments of the present invention is shown. The system 160 of FIG. 1B is similar in most respects to system 100 shown in FIG. 1A, but utilizes a pool 164 to provide additional flexibility for consumer account management. The pool 164 is not necessarily a formal account, per se, but represents a placeholder to control fund allocations and transfers. The consumer device determines a portion of the available pool spending limit 176 to allocate to the card account, or transfer to the primary account or other account 168.

The merchant device 104, banking server 108, employer server, card account 112, primary account 116, secondary account 120, and other account 124 are as described with respect to FIG. 1A. Unless stated otherwise, the interactions between these items are as described with respect to FIG. 1A and only the differences are described with reference to FIG. 1B.

Although transfers from the pool 164 to either the primary account 116 or the other account 124 represent actual funds transfers, a selected portion of funds are instead allocated to the card account 172. Allocated funds represent an accounting scoreboarding function rather than an actual transfer of funds. The banking server 108 calculates an adjusted available pool spending limit 180 and updates the pool 164 with this adjusted amount.

Referring now to FIG. 2, a diagram illustrating a user interface configuration of a designated account 200, in accordance with embodiments of the present invention is shown. FIG. 2 shows an example of a user interface screen for selecting a designated account 212 among several possible accounts. FIG. 2 assumes a user or consumer has previously entered account information for other accounts 124, possibly including an account name, an account number, and a routing number for the applicable bank or financial institution. The user interface 200 commonly would include a page exit control 204 and a select designated account control 208. The page exit control 204 exits from the illustrated screen, and in most embodiments would either route to a previous screen or a higher level or main screen when pressed. The select designated account control 208 enters the highlighted account as the designated account. Up/Down selection arrows 216 may represent one commonly used user interface control type that may be used to scroll through a list to find the desired account. However, other forms of user interface selection controls may be used without deviating from the present invention.

In the illustrated embodiment, there are 5 accounts shown: a primary account 116, a second bank account 212A, a third bank account 212B, a fourth bank account 212C, and a fifth bank account 212D. The currently highlighted account happens to be the second bank account 212A, so that if the select designated account control 208 is pressed at this point, the second bank account 212A will be selected as the designated account 212.

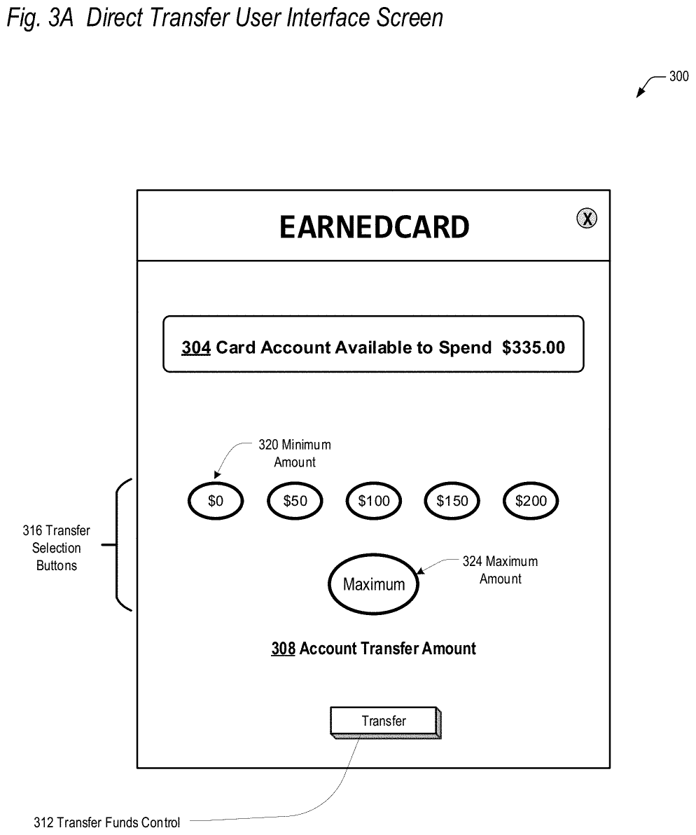

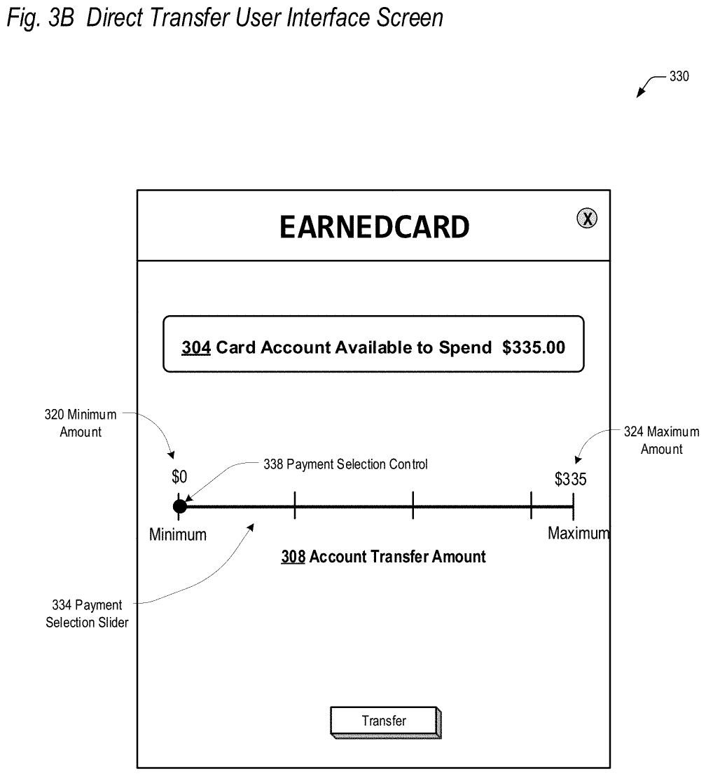

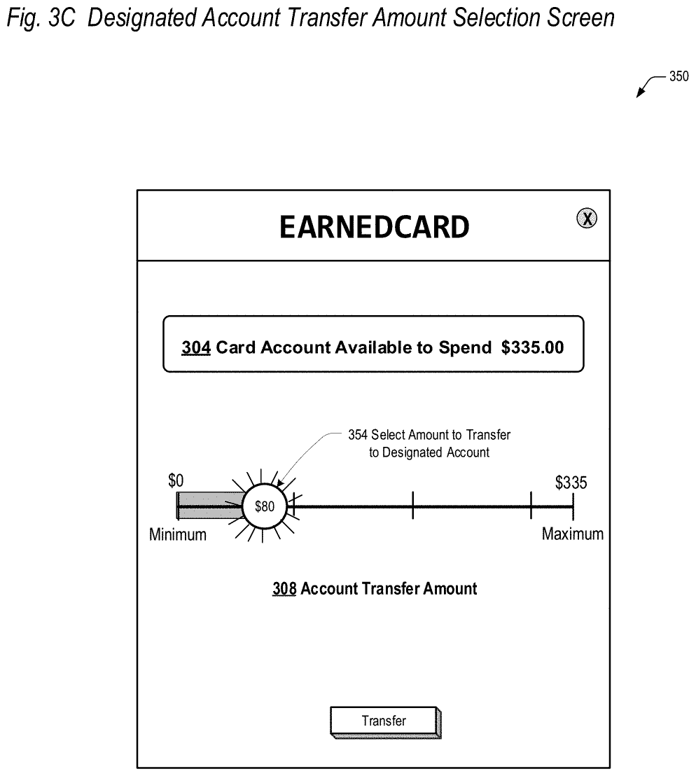

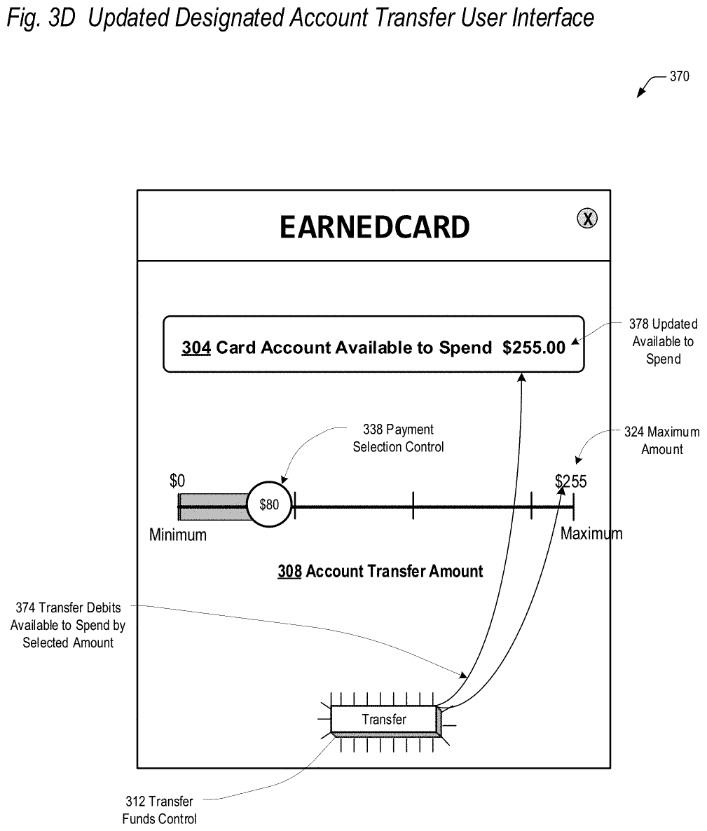

Referring now to FIG. 3A, a diagram illustrating a direct transfer user interface screen 300, in accordance with a first embodiment of the present invention is shown. FIG. 3A illustrates a first embodiment where an account transfer amount 308 is designated by either a number of transfer selection buttons 316 (i.e., “radio buttons” in user interface design parlance) to select either a minimum amount 320, a portion of the card account available to spend 304, or a maximum amount 324. In some embodiments, the minimum amount 320 may be $0, and in other embodiments, the minimum amount 320 may be greater than $0. In some embodiments, the maximum amount 324 may be the full amount of the card account available to spend 304, and in other embodiments, the maximum amount 324 may be less than the full amount of the card account available to spend 304. The embodiment illustrated in FIGS. 3A-3D correspond to the system shown in FIG. 1A, and do not utilize a pool 164 for transfers and allocations.

Referring now to FIG. 3B, a diagram illustrating a direct transfer user interface screen 330, in accordance with a second embodiment of the present invention is shown. FIG. 3B illustrates a second embodiment where an account transfer amount 308 is designated by a payment selection control 338 moved along a payment selection slider 334 under finger or stylus control. The payment selection slider 334 ranges from a minimum amount 320 to a maximum amount 324. In some embodiments, the minimum amount 320 may be $0, and in other embodiments, the minimum amount 320 may be greater than $0. In some embodiments, the maximum amount 324 may be the full amount of the card account available to spend 304, and in other embodiments, the maximum amount 324 may be less than the full amount of the card account available to spend 304. The payment selection slider 334 may either select a discrete amount or any amount between the minimum 320 and the maximum 324 values. In one embodiment, the payment selection control 338 may be moved to only certain regularly spaced values, such as every $100 at the vertical hashmarks along the payment selection slider 334. This may allow the payment selection control 338 to select the minimum value 320, $100, $200, $300, or the maximum value 324. In other embodiments, a different selection granularity may be used, such as every $50, every $10, or some other value. In this embodiment, the same values as shown in FIG. 3A may be selected, although using a different user interface mechanism. In another embodiment, the payment selection control 338 may be moved to select any value between and including the minimum value 320 and the maximum value 324, for example $215. This embodiment may require more precise finger or stylus control in order to select a desired account transfer amount 308.

Referring now to FIG. 3C, a diagram illustrating a designated account transfer amount selection screen 350, in accordance with embodiments of the present invention is shown. FIG. 3C illustrates an example of the second embodiment described with reference to FIG. 3B, where the payment selection control 338 selects any value along the payment selection slider 334. In the example of FIG. 3C, the card account available to spend amount 304 is $335, and the user has selected an amount to transfer to the designated account 354 (FIG. 2, 212) of $80. In the illustrated example, a portion to the left of the payment selection control 338 is shaded to more clearly indicate the current position of the payment selection control 338 along the payment selection slider 334. Other forms of user interface emphasis may be used, including but not limited to a blinking payment selection control 338, a highlighted payment selection control 338, and so forth. The card account transfer amount selection screen 350 does not transfer funds as the payment selection control 338 is moved along the payment selection slider 334; it only allows a user or consumer to select the amount to transfer 308. This allows a user or consumer to make changes to the account transfer amount 308 prior to initiating the transfer itself.

Referring now to FIG. 3D, a diagram illustrating an updated designated account transfer user interface screen 370, in accordance with embodiments of the present invention is shown. In FIG. 3D, an account transfer amount 308 has been selected by the user or consumer using the payment selection control 338, and the user or consumer initiates the selected transfer to the designated account 212 by pressing a transfer funds control 312. Pressing the transfer funds control 312 initiates a transfer 374 that debits the available to spend amount 304 by the selected amount using the payment selection control 338. The available to spend amount is updated 378. In the illustrated example, the selected account transfer amount 308 ($80) is debited from the card account available to spend 304 ($335), resulting in an updated available to spend amount 378 of $255 and a new maximum amount available to transfer 324 of $255. $80 has been transferred from the card account 112 to the designated account 212.

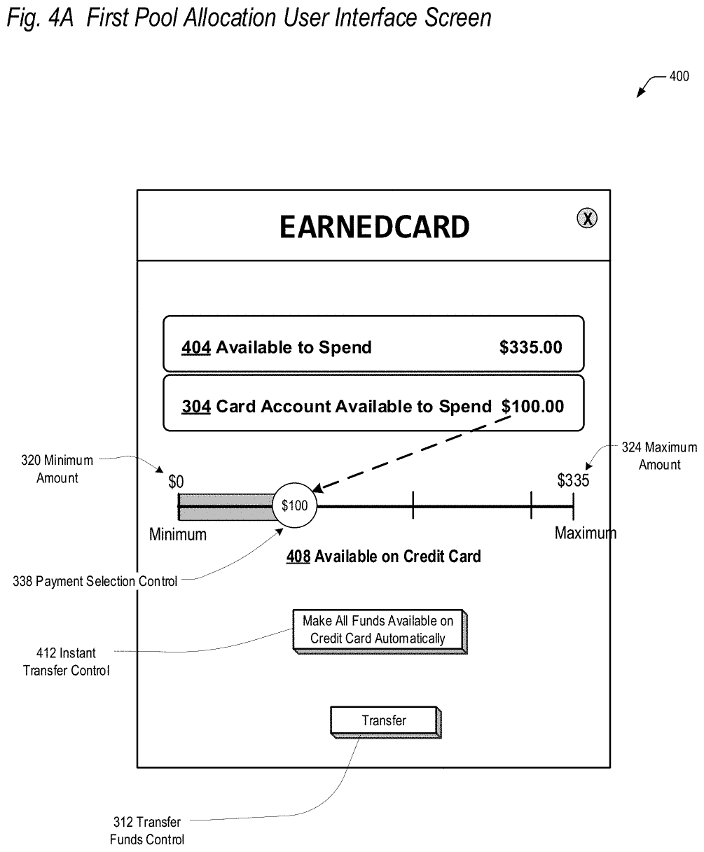

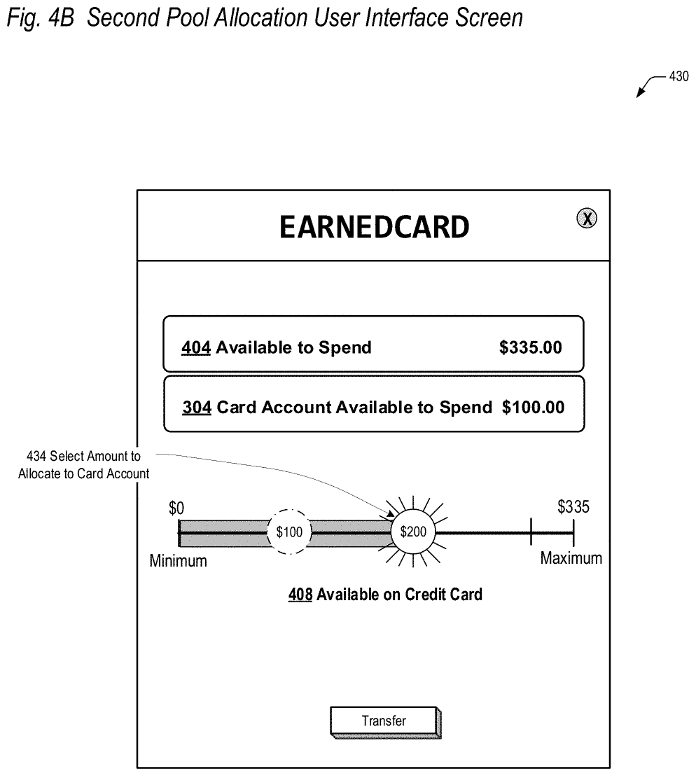

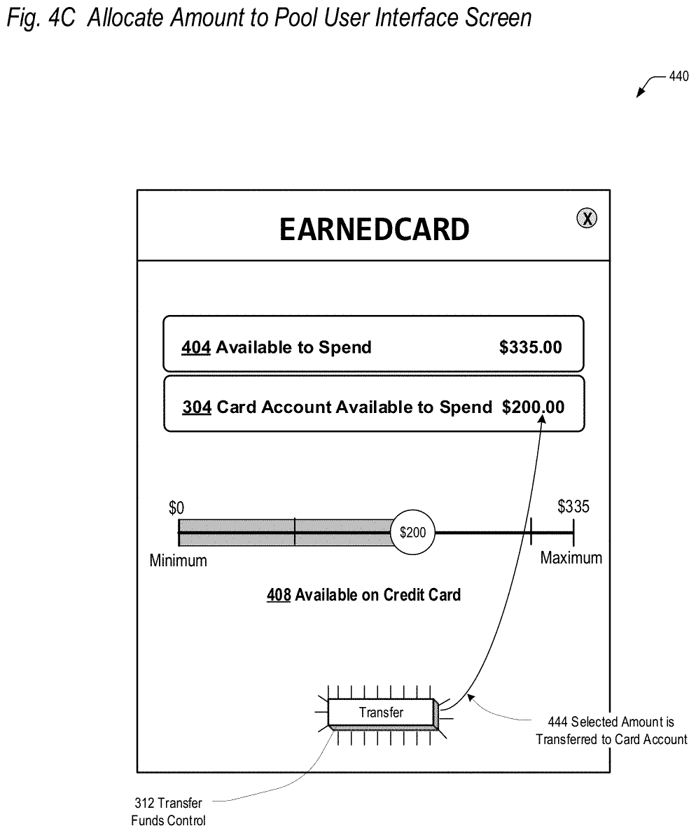

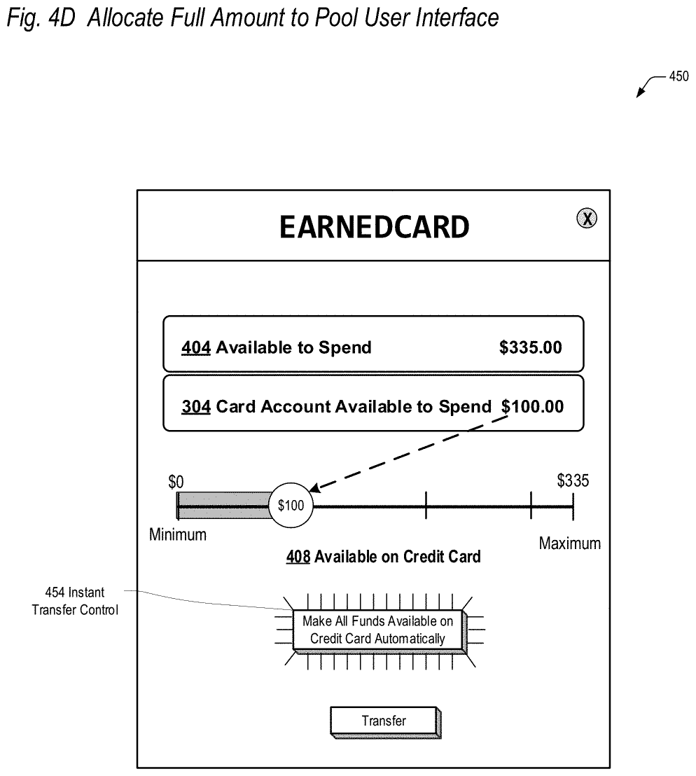

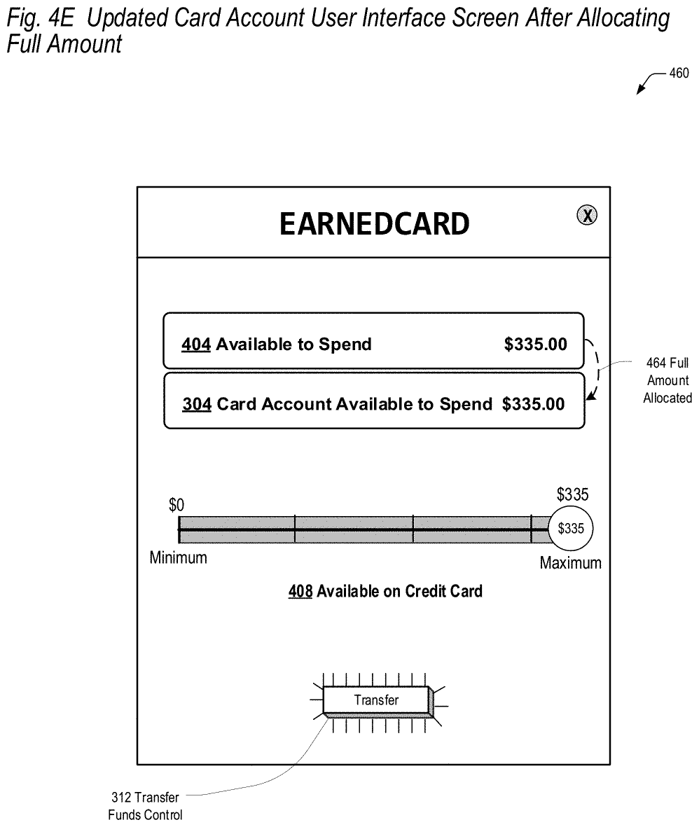

Referring now to FIG. 4A, a diagram illustrating a first pool allocation user interface screen 400, in accordance with embodiments of the present invention is shown. FIGS. 4A-4E illustrate an example embodiment for account transfers and allocations, using the system of FIG. 1B, including a pool 164. FIGS. 4A-4C illustrate selecting an amount to allocate to the card account 112 that is less that the full available amount. FIGS. 4D-4E illustrate selecting an amount to allocate to the card account 112 that is the full available amount. The user interface of FIG. 4A includes an available to spend amount 404, a card account available to spend amount 304, an available on credit card amount 408, an instant transfer control 412, and a transfer funds control 312. In the illustrated embodiment, a payment selection control 338 is used in conjunction with a payment selection slider 334 to select an available on credit card amount 408 on or between the minimum amount 320 and the maximum amount 324. In the example illustrated, the minimum amount 320 is $0 and the maximum amount 324 is the available to spend amount 404 ($335). When the user interface screen 400 of FIG. 4A is initially entered, the payment selection control 338 reflects the card account available to spend 304 ($100).

Referring now to FIG. 4B, a diagram illustrating a second pool allocation user interface screen 430, in accordance with embodiments of the present invention is shown. A user or consumer wishes to allocate an additional $100 to the card account 112, and moves the payment selection control 338 to the right to “$200”, which selects 434 ($200) to allocate to the card account 112.

Referring now to FIG. 4C, a diagram illustrating an allocate amount to pool user interface screen 440, in accordance with embodiments of the present invention is shown. Once the user or consumer has moved the payment selection control 338 to the desired available on credit card amount 408 ($200), the transfer funds control 312 is activated, which results in the selected amount ($200) allocated 444 to the card account 112. The card account available to spend 304 is updated ($200) when the transfer funds control 312 is pressed.

Referring now to FIG. 4D, a diagram illustrating an allocate full amount to pool user interface screen 450, in accordance with embodiments of the present invention is shown. The example user interface screen of FIGS. 4D-4E reflects an option whereby the entire available to spend amount 404 ($335) is allocated. In FIG. 4D, an instant transfer control 454 is activated by the user or consumer. Alternately, the user or consumer may move the payment selection control 338 all the way to the right to select the maximum amount ($335).

Referring now to FIG. 4E, a diagram illustrating an updated card account user interface screen after allocating the full amount 460, in accordance with embodiments of the present invention is shown. The user or consumer activates the transfer funds control 312, which allocates the full available amount 404 to the card account 112. The card account available to spend amount 304 is updated to reflect the full amount is allocated 464 ($335).

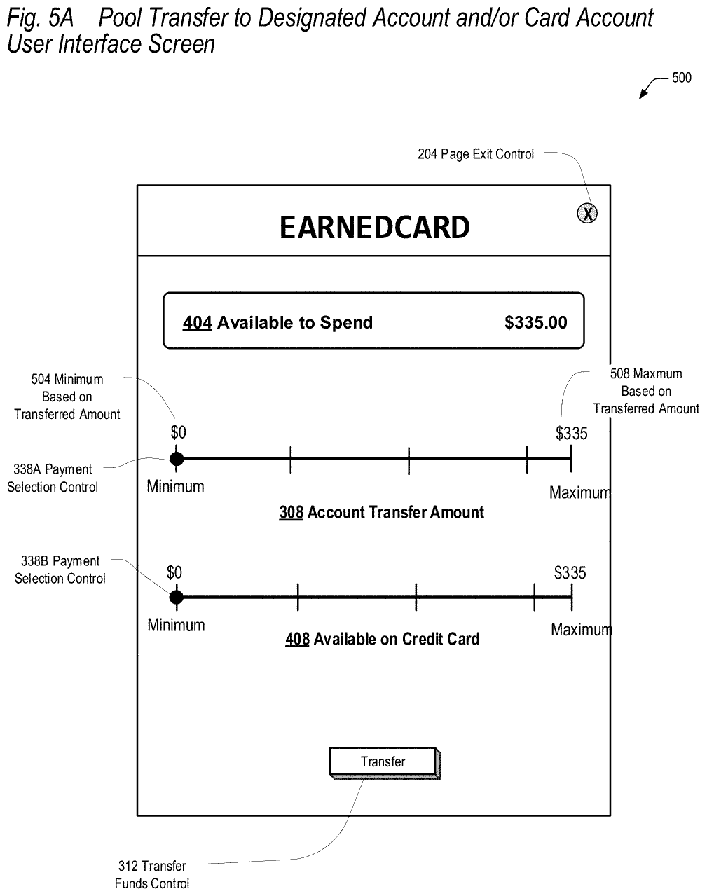

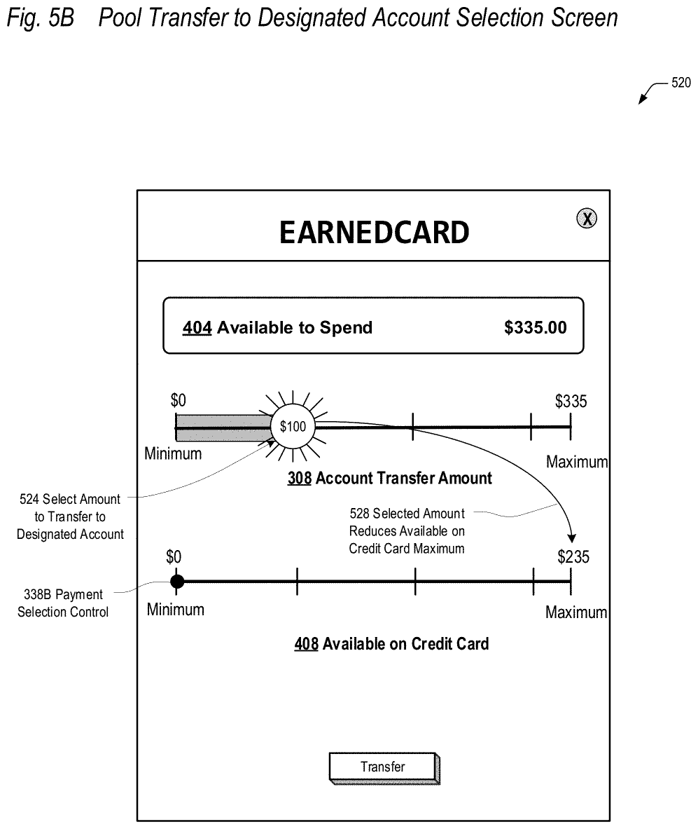

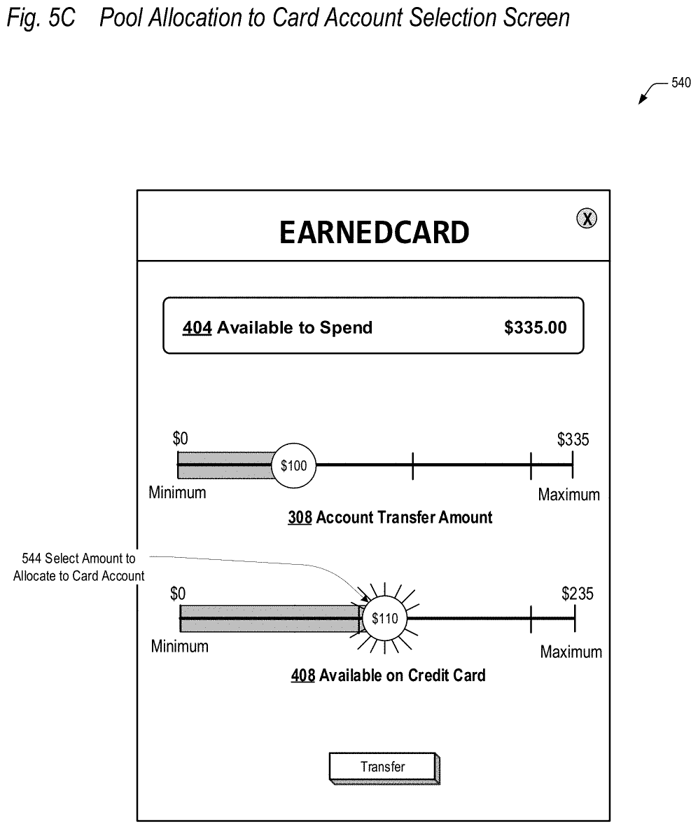

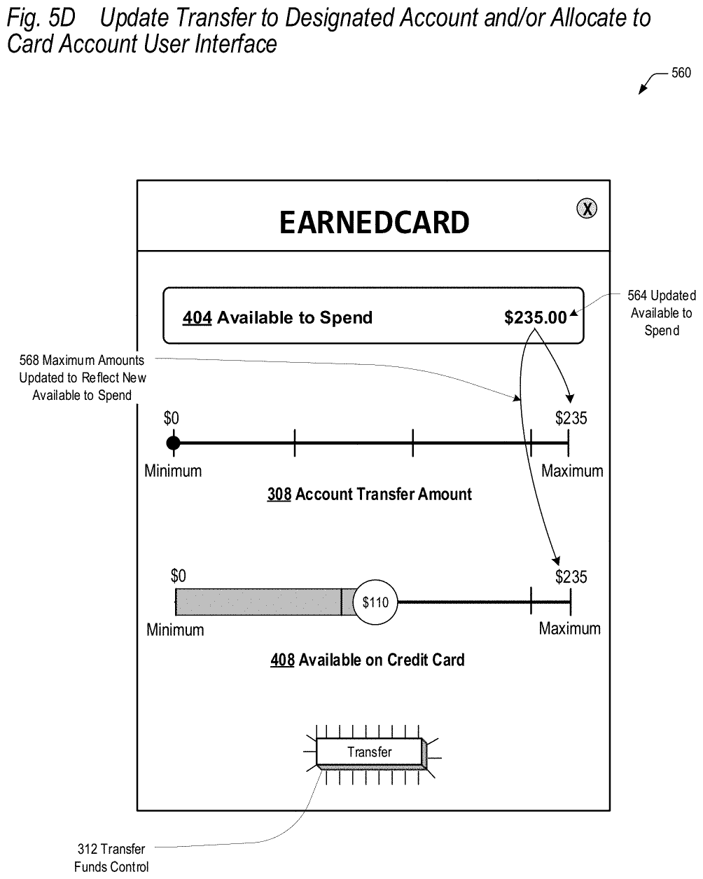

Referring now to FIG. 5A, a diagram illustrating a pool transfer to a designated account and/or a card account user interface screen 500, in accordance with embodiments of the present invention is shown. FIG. 5A illustrates an embodiment where two allocation/transfer selection controls are provided for a pool-based embodiment—one for account transfer 308 to the designated account 212, and another for allocation to the card account 408. The account transfer control 308 includes a minimum 504 and a maximum 508 amount based on the transferred amount. The account transfer control 308 includes a first payment selection control 338A, and the available on credit card control 408 includes a second payment selection control 338B. A transfer funds control 312 is provided in order to transfer and allocate funds. In the example illustrated, the minimum amount 504 is $0 and the maximum amount 508 is the available to spend amount 404 ($335).

Referring now to FIG. 5B, a diagram illustrating a pool transfer to designated account selection screen 520, in accordance with embodiments of the present invention is shown. FIG. 5B illustrates the user interface after a user or consumer has moved the first payment selection control 338A for the account transfer amount 308 to select $100 to transfer to the designated account 524. A user or consumer typically transfers funds to the designated account 212 in order to obtain cash. By moving the first payment selection control 338 to $100, the maximum amount for the available on credit card 408 slider is reduced by the same amount $100 to $235 maximum. The selected amount therefore reduces the available on credit card maximum 528.

Referring now to FIG. 5C, a diagram illustrating a pool allocation to card account selection screen 540, in accordance with embodiments of the present invention is shown. In the illustrated embodiment, the user or consumer has selected $100 to be transferred to the designated account 212, and now wishes to allocate a portion of the remaining funds ($235) to the card account 112. The user or consumer moves the second payment selection control 338B for the available on credit card slider 408 to select $110 to be allocated to the card account 544. Thus, at this point $210 out of the $335 available to spend amount 404 has been designated to transfer and allocate.

Referring now to FIG. 5D, a diagram illustrating an update transfer to designated account and/or allocate to card account user interface screen 560, in accordance with embodiments of the present invention is shown. The user or consumer has previously performed the steps in FIGS. 5B and 5C, and prior to activating the transfer funds control 312, the available to spend amount 404 reflects an updated available to spend amount 564 ($235) and the maximum amounts for the account transfer amount slider 308 and the available on credit card slider 408 are updated 568 to reflect the new available to spend amount ($235).

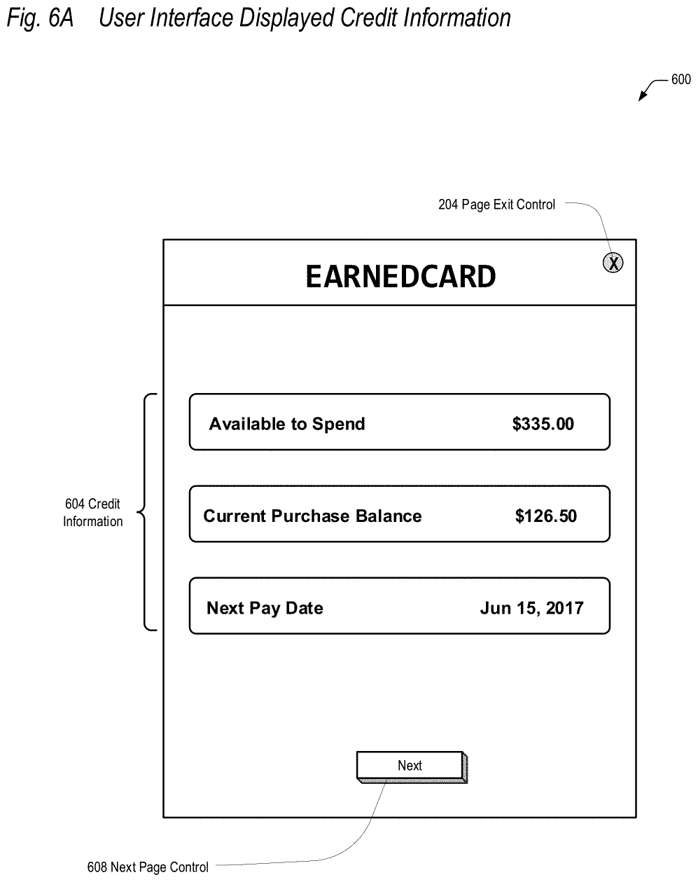

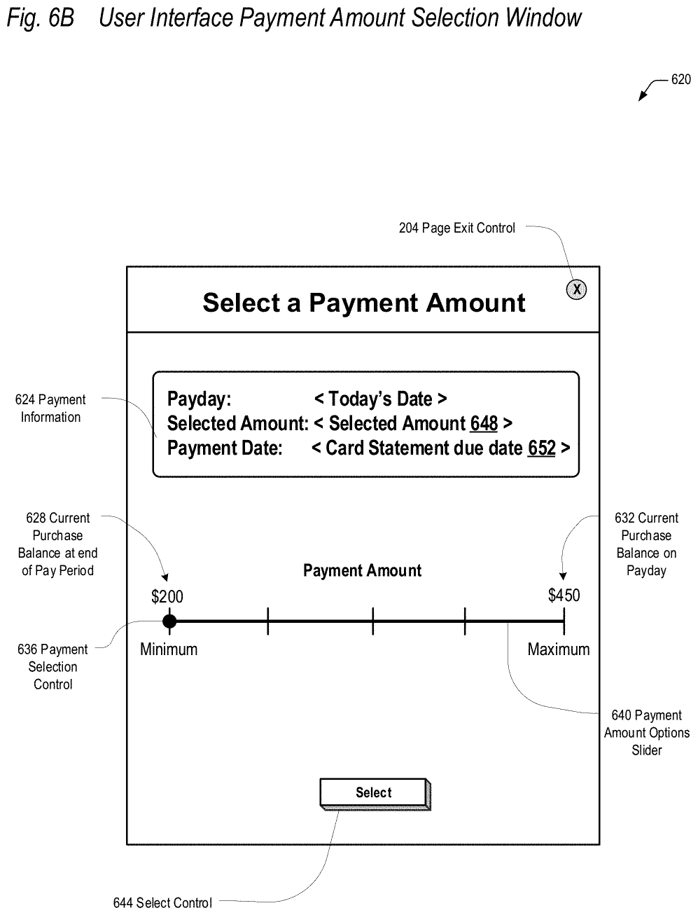

Referring now to FIG. 6A, a diagram illustrating a displayed credit information user interface screen 600, in accordance with embodiments of the present invention is shown. The user interface window is displayed on a client device when the client device receives a credit information notification from the banking server 108 and presents the credit information to the employee or consumer. In one embodiment, the client device may receive the credit information notification each day. In another embodiment, the credit information notification may be received by the client device whenever there is any of an approved purchase transaction 128, a payment is received by the primary account 116, a payment is received by the secondary account 120, or there is a change in the available spending limit 132. In another embodiment, the banking server 108 transfers updates to the client device asynchronously as credit information changes, and the client device includes an application that displays the updated credit information when the application is invoked by the employee or consumer. In another embodiment, the user initiates an update of the information by “pulling down” the screen.

FIG. 6A represents one of many such possible examples, and such information can be presented in countless other ways without deviating from the scope and intent of the present application. Each of the fields and information shown may or may not be presented in other examples or presented in a similar fashion to that illustrated herein. The following description therefore applies to the illustrated example, and may or may not apply to other possible examples.

The user interface window 600 may include a page exit control 204, which terminates the displayed page and returns the display to a previous state (i.e. whatever was being displayed prior to the present window). The user interface page 600 may also include some form of credit information 604, from which a user or consumer may obtain current credit-related information related to card usage. In one embodiment, the credit information 604 may include a next pay date (i.e. a next payday 144), a current purchase balance, and an available to spend amount (i.e. the available spending limit 132 or the available pool spending limit 176). In another embodiment, the credit information 604 may include any of the primary account 116 balance, the secondary account balance 120, the card account statement balance due, the total accrued fractional earnings, the spending limit, and/or the purchase balance. In other embodiments, less, more, or different information may be provided. Finally, the user interface 600 may include a next page control 608 or other control for navigation or other purposes.

Referring now to FIG. 6B, a diagram illustrating a user interface payment amount selection screen 620, in accordance with embodiments of the present invention is shown. The user interface payment selection screen 620 may be used for embodiments where the employee or consumer is able to specify the amount of funds transferred from the primary 116 to the secondary 120 account on each payday 144. This embodiment may be beneficial to consumers by helping to achieve a higher credit score or credit rating when more funds are transferred.

The payment amount selection window 620 includes payment information 624 that provides some information about the payment to be made that assists the employee or consumer to understand the payment schedule and assess options for payment. In one embodiment, the payment information 624 may include a payday 144 date, a selected amount 648, and the card statement due date 652. In other embodiments, the payment information 624 may include additional or different information. The payday 144 in most embodiments is the current date, since the notification producing the payment amount selection window 620 is send from the banking server 108 to the client device on the payday 144. The selected amount 648 is the amount selected by the employee or consumer using a payment selection control 636 or other form of control. The employee or consumer verifies the selected amount 648 reflects their desires prior to activating the select control 644. The payment date 652 is the date on the card statement at which the card account 112 will be paid from the secondary account 120.

In the example illustrated, a payment amount options slider 640 is shown. This is a linear graphic including at least a minimum payment amount (i.e. current purchase balance at the end of the most recent completed pay period 628) and a maximum amount (i.e. current purchase balance on the payday 632). The example shows five potential payment amounts, including a minimum example amount of $200 and a maximum example amount of $450. A user (employee or consumer) selects the payment amount using the payment selection control 636. Although the three intermediate steps do not show a corresponding payment amount, in some embodiments the payment amount for the intermediate payment amounts is displayed, as well. In another embodiment, only the minimum 628 and maximum 632 payment amounts are displayed on the payment amount options slider 640, and the payment selection control 636 is controlled by the employee or consumer to select any dollar amount between the minimum 628 and maximum 632. The selected dollar amount would be displayed, such as in selected amount 648 of payment information 624.

Depending on the factors previously discussed, the minimum 628 and maximum 632 payment amounts may be calculated differently than shown in order to accommodate different objectives. Other user interface embodiments known in the art may equivalently provide a payment selection control 636 function, including but not limited to selecting an item from a dropdown list, selecting an item with a radio button, typing in a selected payment amount, rotating a dial, etc.

In the embodiment illustrated, simply moving the payment selection control 636 along the payment amount options slider 640 does not make a payment, by itself. An employee or consumer may change their mind while moving the payment selection control 636 or may accidentally move the payment selection control 636 to a non-desired payment amount. Once the employee or consumer is satisfied the payment selection control 636 position reflects the desired payment amount (for example, by verifying the correct selected amount 648), the employee or consumer activates the select control 644, which selects the payment amount identified by the payment selection control 636 and transmits the selection to the banking server 108. The banking server 108 then schedules the card account payment at the card statement due date 652 for the selected amount 648.

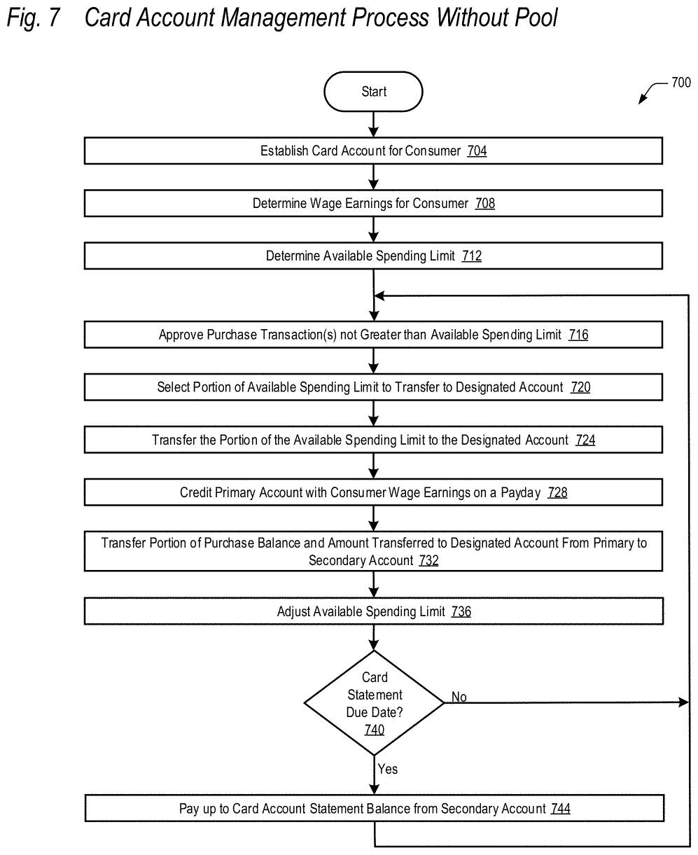

Referring now to FIG. 7, a flowchart illustrating a card account management process without a pool 700, in accordance with embodiments of the present invention is shown. Flow begins at block 704.

At block 704, a card account 112 is established for a consumer. Flow proceeds to block 708.

At block 708, wage earnings are determined for the consumer. Wage earnings may be determined for any method of payment: hourly, salaried, on a project basis, or based upon government payments. Flow proceeds to block 712.

At block 712, the available spending limit 132 is determined. The available spending limit 132 is equal to the spending limit minus a sum of the purchase balance and a transfer balance (i.e. an amount transferred to the designated account 116, 124). The spending limit includes total accrued fractional earnings, total accrued fractional earnings include a sum of fractional earnings, and fractional earnings include a predetermined fraction of the wage earnings. The predetermined fraction is based on average wage earnings and financial obligations for the consumer.

In one embodiment, a credit limit is established for the card account 112. The available spending limit 132 is based on the purchase balance, the credit limit, a sum of fractional earnings for which the consumer has not been paid, and the secondary account 120 balance. Flow proceeds to block 716.

At block 716, purchase transactions 128 not greater than the available spending limit 132 are approved. Flow proceeds to block 720.

At block 720, a portion of the available spending limit 132 is selected to transfer to the designated account 116, 124. The designated account 116, 124 is configured using the process shown in FIG. 2, or an alternative process. Flow proceeds to block 724.

At block 724, the portion of the available spending limit 132 is transferred to the designated account 116, 124. Flow proceeds to block 728.

At block 728, the primary account 116 is credited with consumer wage earnings 140 on a payday 144. Flow proceeds to block 732.

At block 732, an amount equal to a portion of the sum of the transfer balance and the purchase balance is transferred from the primary account 116 to the secondary account 120. The portion of the purchase balance transferred may be equal to the lesser of a current purchase balance and a sum of fractional earnings of a pay period corresponding to the payday 144.

In one embodiment, the user or consumer may be notified of a current purchase balance based on a difference between the purchase balance and the secondary account balance. The banking server receives from the consumer a selected payment amount 648 that includes an amount at or between the current purchase balance at an end of a pay period and the current purchase balance on the payday 144. The selected payment amount 648 is then transferred from the primary account 116 to the secondary account 120 on or after the payday 144 and up to the card account statement balance 148 may be transferred from the secondary account 120 to the card account 112 on or before a card account statement due date 652.

In one embodiment, the card account 112 may include or be the same as the secondary account 120, and the transferred amount corresponding to the portion of the purchase balance may be applied to the card account 112 on or before a card account statement due date 652. Flow proceeds to block 736.

At block 736, the available spending limit is adjusted 152. The adjusted available spending limit 152 is based on the total accrued fractional earnings, the purchase balance, the transfer balance, and the secondary account balance. Flow proceeds to decision block 740.

At decision block 740, a determination is made if the card statement due date has been reached. If the card statement due date has not been reached, then flow proceeds to block 716 to check for more purchase transactions. If instead the card statement due date has been reached, then flow proceeds to block 744.

At block 744, up to the card account statement balance is paid from the secondary account 120. The card account statement balance is paid from the secondary account 120 to the card account 112 on or before a card account statement due date 652. Flow proceeds to block 716 to check for more purchase transactions 128.

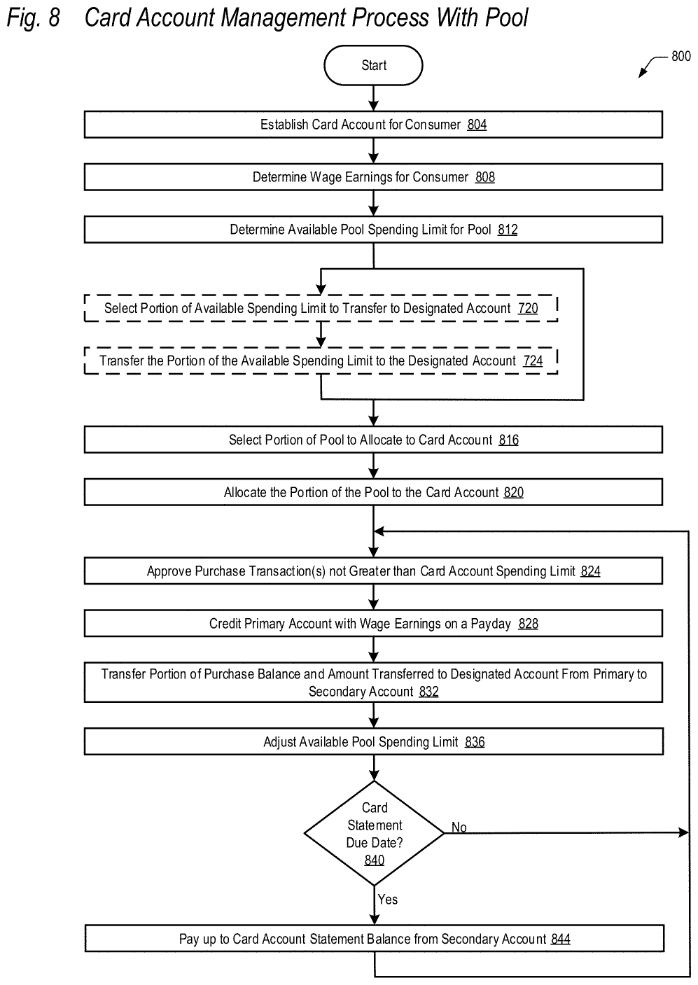

Referring now to FIG. 8, a flowchart illustrating a card account management process with a pool 800, in accordance with embodiments of the present invention is shown. Flow begins at block 804.

At block 804, a card account 112 is established for a consumer. Flow proceeds to block 808.

At block 808, wage earnings are determined for the consumer. Wage earnings may be determined for any method of payment: hourly, salaried, on a project basis, or based upon government payments. Flow proceeds to block 812.

At block 812, an available pool spending limit 176 is determined for a pool 164. The available pool spending limit 176 is equal to the spending limit minus a sum of the purchase balance and a transfer balance 172 between the pool 164 and a designated account 212. The spending limit includes total accrued fractional earnings, total accrued fractional earnings include a sum of fractional earnings, and fractional earnings include a predetermined fraction of the wage earnings. The predetermined fraction is based on average wage earnings and financial obligations for the consumer.

In one embodiment, a credit limit is established for the card account 112. The available pool spending limit 176 is based on the purchase balance, the credit limit, a sum of fractional earnings for which the consumer has not been paid, and the secondary account 120 balance. Flow proceeds to block 816 and optional block 720.

In one embodiment reflected in FIGS. 5A-5D, a user or consumer may transfer a portion of the available pool spending limit 176 is selected to transfer to the designated account 116, 124. The designated account 116, 124 is configured using the process shown in FIG. 2, or an alternative process. Flow proceeds to optional block 724.

At optional block 724, the portion of the available pool spending limit 176 is transferred to the designated account 116, 124. Flow proceeds to block 816.

At block 816, a portion of the pool 164 is selected using a first user interface control 338B to allocate to the card account 112. The allocated portion is not transferred as funds to the card account 112, but is instead presented as an accounting transaction. Flow proceeds to block 820.

At block 820, the selected portion of the pool 164 is allocated to the card account 112. In one embodiment, a second user interface control 338A selects a portion of the pool to transfer to the designated account 212 as the transfer balance. Flow proceeds to block 824.

At block 824, purchase transactions 128 not greater than the card account spending limit are approved. Flow proceeds to block 828.

At block 828, the primary account 116 is credited with wage earnings 140 on a payday 144. Flow proceeds to block 832.

At block 832, an amount equal to a portion of the sum of the transfer balance and the purchase balance is transferred from the primary account 116 to the secondary account 120. The portion of the purchase balance transferred may be equal to the lesser of a current purchase balance and a sum of fractional earnings of a pay period corresponding to the payday 144.

In one embodiment, the user or consumer may be notified of a current purchase balance based on a difference between the purchase balance and the secondary account balance. The banking server receives from the consumer a selected payment amount 648 that includes an amount at or between the current purchase balance at an end of a pay period and the current purchase balance on the payday 144. The selected payment amount 648 is then transferred from the primary account 116 to the secondary account 120 on or after the payday 144 and up to the card account statement balance 148 may be transferred from the secondary account 120 to the card account 112 on or before a card account statement due date 652. Flow proceeds to block 836.

At block 836, the available pool spending limit is adjusted 180. The adjusted available pool spending limit 180 is based on the total accrued fractional earnings, the purchase balance, the transfer balance, and the secondary account balance. Flow proceeds to block 840.

At block 840, a determination is made if the card statement due date has been reached. If the card statement due date has not been reached, then flow proceeds to block 824 to check for more purchase transactions 128. If instead the card statement due date has been reached, then flow proceeds to block 844.

At block 844, up to the card account statement balance is paid from the secondary account 120. The card account statement balance is paid from the secondary account 120 to the card account 112 on or before a card account statement due date 652. Flow proceeds to block 824 to check for more purchase transactions 128.

A mechanism for providing a card account management system that allows consumers to reserve funds to pay their card bill has been described. It will be appreciated by those skilled in the art that the system and method of the present invention can be used in environments other than those disclosed herein. It will thus be appreciated by those skilled in the art that other variations of the present invention will be possible without departing from the scope of the invention as disclosed. These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention, therefore the above description should not be considered to be exclusive of these other embodiments. Also, it is to be understood that the phraseology and terminology employed herein are for the purposes of description and should not be regarded as limiting.

The descriptions and figures included herein depict specific embodiments to teach those skilled in the art how to make and use the best option. For the purpose of teaching inventive principles, some conventional aspects have been simplified or omitted. Those skilled in the art will appreciate variations from these embodiments that fall within the scope of the invention. Those skilled in the art will also appreciate that the features described above can be combined in various ways to form multiple embodiments. As a result, the invention is not limited to the specific embodiments described above, but only by the claims and their equivalents.

Finally, those skilled in the art should appreciate that they can readily use the disclosed conception and specific embodiments as a basis for designing or modifying other structures for carrying out the same purposes of the present invention without departing from the spirit and scope of the invention as defined by the appended claims.

We claim:

1. A method comprising:
establishing a card account for a consumer:
determining, by a banking server, wage earnings for the consumer;
determining, by the banking server, an available spending limit equal to a spending limit minus a sum of a purchase balance and a transfer balance, the spending limit comprising total accrued fractional earnings, the total accrued fractional earnings comprising a sum of fractional earnings, and fractional earnings comprising a predetermined fraction of the wage earnings;
approving, by the banking server, one or more purchase transactions for the card account not greater than the available spending limit;
selecting, by a-user interface control, the transfer balance comprising a portion of the available spending limit to transfer to a designated account;
transferring the transfer balance to the designated account;
crediting, by an employer server, a primary account with the wage earnings on a payday, and in response:
transferring, by the banking server, an amount equal to a portion of the sum of the transfer balance and the purchase balance from the primary account to a secondary account on or after the payday, the secondary account comprising a secondary account balance for storing funds to pay a card account statement balance; and
adjusting, by the banking server, the available spending limit based on the total accrued fractional earnings, the purchase balance, the transfer balance, and the secondary account balance.

2. The method of claim 1, further comprising:
transferring up to the card account statement balance from the secondary account to the card account on or before a card account statement due date.

3. The method of claim 1, wherein the card account comprises the secondary account, the method further comprising:
applying the transferred amount corresponding to the portion of the purchase balance to the card account on or before a card account statement due date.

4. The method of claim 1, wherein the amount equal to the portion of the purchase balance transferred is equal to the lesser of:
a current purchase balance and a sum of fractional earnings of a pay period corresponding to the payday.

5. The method of claim 1, wherein the predetermined fraction is based on average wage earnings and financial obligations for the consumer.

6. The method of claim 1, further comprising:
setting a credit limit for the card account,
wherein the available spending limit is based on the purchase balance, the credit limit, a sum of fractional earnings for which the consumer has not been paid, and the secondary account balance.

7. The method of claim 1, further comprising:
notifying the consumer of a current purchase balance based on a difference between the purchase balance and the secondary account balance;
receiving, from the consumer, a selected payment amount comprising an amount at or between the current purchase balance at an end of a pay period and the current purchase balance on the payday;
transferring the selected payment amount from the primary account to the secondary account on or after the payday; and
transferring up to the card account statement balance from the secondary account to the card account on or before a card account statement due date.

8. A system, comprising:
a network;
a merchant device, coupled to the network, configured to perform one or more purchase transactions for a consumer using a card account;
a secondary account, coupled to the network;
a consumer device, coupled to the network, comprising:
a user interface comprising:
a payment selection slider configured to allow the consumer to select a transfer balance comprising a portion of an available spending limit to transfer to a designated account;
a banking server, coupled to the network, configured to:
receive payment instructions related to the consumer;
calculate consumer wage earnings from the payment instructions; and
approve the one or more purchase transactions not greater than the available spending limit for the card account, the available spending limit equal to a spending limit minus a sum of a purchase balance for the card account and the transfer balance, the spending limit comprising total accrued fractional earnings, the total accrued fractional earnings comprising a sum of fractional earnings, and the fractional earnings comprising a predetermined fraction of the consumer wage earnings; and
receive the transfer balance from the consumer device, and in response:
reduce the available spending limit by the transfer balance; and
an employer server, coupled to the network, configured to:
transfer the consumer wage earnings to a primary account on a payday; and
in response to the employer server configured to transfer the consumer wage earnings, the banking server is further configured to:
transfer an amount equal to a portion of the sum of the transfer balance and the purchase balance from the primary account to the secondary account on or after the payday;
transfer up to a card account statement balance from the secondary account to the card account on or before a card statement due date; and
adjust the available spending limit based on the total accrued fractional earnings, the purchase balance, the transfer balance, and the secondary account balance.

9. The system of claim 8, wherein the card account comprises the secondary account, and wherein the banking server is further configured to:
apply the transferred amount corresponding to the portion of the purchase balance to the card account on or before the card statement due date.

10. The system of claim 8, wherein the amount equal to the portion of the purchase balance transferred is equal to the lesser of:
a current purchase balance and a sum of fractional earnings of a pay period that corresponds to the payday.

11. The system of claim 8, wherein the predetermined fraction is based on average consumer wage earnings and financial obligations for the consumer.

12. The system of claim 8, the banking server being further configured to:
establish the card account for the consumer;
authorize transfers from the primary account to the secondary account, the primary account storing wage earnings for the consumer, and the secondary account comprising a secondary account balance for paying the card account statement balance;
set a credit limit for the card account;
determine an available spending limit for the card account; and
adjust the available spending limit based on the credit limit, a sum of fractional earnings for which the consumer has not been paid, the purchase balance, and the secondary account balance.

13. The system of claim 8, further comprising:
the consumer device, coupled to the network, comprising an application configured to display one or more of:
the available spending limit;
a current purchase balance based on a difference between the purchase balance and the secondary account balance; and
a date of a next payday.

14. The system of claim 13, wherein the banking server is further configured to:
provide a notification to the consumer device of the current purchase balance;
receive, from the consumer device, a selected payment amount comprising an amount at or between the current purchase balance at the end of a pay period and the current purchase balance on the payday;
transfer the selected payment amount from the primary account to the secondary account on or after the payday; and
transfer up to the card account statement balance from the secondary account to the card account on or before the card statement due date.

15. A non-transitory computer readable storage medium configured to store instructions that when executed cause a processor to:
establish a card account for a consumer;
determine, by a banking server, wage earnings for the consumer;
determine, by the banking server, an available spending limit equal to a spending limit minus a sum of a purchase balance and a transfer balance, the spending limit comprising total accrued fractional earnings, the total accrued fractional earnings comprising a sum of fractional earnings, and fractional earnings comprising a predetermined fraction of the wage earnings;
approve, by the banking server, one or more purchase transactions for the card account not greater than the available spending limit;
select, by a-user interface control, the transfer balance comprising a portion of the available spending limit to transfer to a designated account;
transfer the transfer balance to the designated account;
credit, by an employer server, a primary account with the wage earnings on a payday, and in response:
transfer, by the banking server, an amount equal to a portion of the sum of the transfer balance and the purchase balance from the primary account to a secondary account on or after the payday, the secondary account comprising a secondary account balance for storing funds to pay a card account statement balance; and
adjust, by the banking server, the available spending limit based on the total accrued fractional earnings, the purchase balance, the transfer balance, and the secondary account balance.

16. The non-transitory computer readable storage medium of claim 15, further configured to store instructions that when executed cause the processor to:
transfer up to the card account statement balance from the secondary account to the card account on or before a card account statement due date.

17. The non-transitory computer readable storage medium of claim 15, further configured to store instructions that when executed cause the processor to:
apply the transferred amount corresponding to the portion of the purchase balance to the card account on or before a card account statement due date, wherein the card account comprises the secondary account.

18. The non-transitory computer readable storage medium of claim 15, wherein the amount equal to the portion of the purchase balance transferred is equal to the lesser of:
a current purchase balance and a sum of fractional earnings of a pay period corresponding to the payday,
wherein the predetermined fraction is based on average wage earnings and financial obligations for the consumer.

19. The non-transitory computer readable storage medium of claim 15, further configured to store instructions that when executed cause the processor to:
set a credit limit for the card account,
wherein the available spending limit is based on the purchase balance, the credit limit, a sum of fractional earnings for which the consumer has not been paid, and the secondary account balance.

20. The non-transitory computer readable storage medium of claim 15, further configured to store instructions that when executed cause the processor to:
notify the consumer of a current purchase balance based on a difference between the purchase balance and the secondary account balance;
receive, from the consumer, a selected payment amount comprising an amount at or between the current purchase balance at an end of a pay period and the current purchase balance on the payday;
transfer the selected payment amount from the primary account to the secondary account on or after the payday; and
transfer up to the card account statement balance from the secondary account to the card account on or before a card account statement due date.

21. A user interface, comprising:
an available to spend amount for a card account, comprising a spending limit minus a sum of a purchase balance and a transfer balance, the spending limit comprising total accrued fractional earnings, the total accrued fractional earnings comprising a sum of fractional earnings, and fractional earnings comprising a predetermined fraction of consumer wage earnings, the available to spend amount initially reflects an amount that may be spent on a credit card;
a sliding payment selection control, configured to allow a consumer to select a portion of the available to spend amount to transfer to a designated account, the selected portion ranges from a minimum amount up to the available to spend amount, the sliding payment selection control reflects the minimum amount when the user interface is invoked;
a transfer funds control, configured to authorize transfer of the selected portion to a banking server and reduce the available to spend amount by the selected portion.
